(19) United States
(12) Patent Application Publication
(10) Pub. No.: US 2021/0126879 A1
(43) Pub. Date: Apr. 29, 2021

(54) AUTOMATIC OUTBOUND INSTANT MESSAGES

(71) Applicant: Beijing Yi Zhang Yun Feng Technology Co., Ltd., Beijing (CN)

(72) Inventors: Shaozhuang Liu, Beijing (CN); Qian Huang, Beijing (CN); Junyan Liu, Beijing (CN); Cui Jianxun, Beijing (CN); Sheng Xi, Beijing (CN); Cui Kaizin, Beijing (CN)

(21) Appl. No.: 16/634,826

(22) PCT Filed: Jul. 28, 2017
(86) PCT No.: PCT/CN2017/094969

§ 371 Date: Jan. 28, 2020

(51) Int. Cl. H04L 12/58; H04L 29/08; H04M 3/42; H04M 3/51

(52) U.S. Cl. CPC H04L 51/04; H04L 51/32; H04M 3/5158; H04L 67/141; H04M 3/42382; H04L 51/02

(57) ABSTRACT

A plurality of outbound instant message invitations that are not connected to sessions can be sent to a plurality of end-users. When an end-user interacts with the invitation, a session is created with the responding user on one end and an agent on the other. The agent can use a virtual identifier that remains the same when the agent transfers the session to other agents.

### TECHNICAL FIELD

The present disclosure generally relates to machines configured to the technical field of special-purpose machines that manage electronic communications over a network and improvements to such variants, and to the technologies by which such special-purpose machines become improved compared to other special-purpose machines for managing automatic outbound instant messages (IM).

### BACKGROUND

Users can communicate over a network using real-time communication channels (e.g., instant messaging, chat sessions). A user can be on one end of a real-time communication session and another user can be on the other end of the real-time communication session, and the two users can send and receive text to and from each other in real-time or near real-time. The real-time communication sessions typically follow an agreed upon network protocol, and it can be difficult, if not impossible, to set up real-time communication channels between a multitude of users and manage transfers between those users.

### BRIEF DESCRIPTION OF THE DRAWINGS

Various ones of the appended drawings merely illustrate example embodiments of the present disclosure and should not be considered as limiting its scope.

FIG. 1 is a diagram illustrating a current environment for providing automatic outbound instant messaging (IM), according to some example embodiments.

FIG. 2 shows a high-level network architecture of an outbound IM system implementing outbound invitations, according to some example embodiments.

FIG. 3 shows example functional components of an outbound IM system, according to some example embodiments.

FIG. 4 shows a flow diagram of a method for implementing an outbound IM system with consistent virtual IDs, according to some example embodiments.

FIG. 5 shows a flow diagram of a method for transferring and storing outbound communications, according to some example embodiments.

FIG. 6 shows a user interface for setting up outbound invitations using the outbound IM system, according to some example embodiments.

FIG. 7 shows an administrative user interface for editing message content and other outbound message parameters, according to some example embodiments.

FIG. 8 shows an end-user interface displaying an outbound invitation, according to some example embodiments.

FIG. 9 shows a real-time communication channel between an end-user and an agent set up by the outbound IM system, according to some example embodiments.

FIG. 10 shows an administrative user interface for transferring communication sessions, according to some example embodiments.

FIG. 11 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Users can communicate over a network using real-time communication channels (e.g., instant messaging, chat sessions). A user can be on one end of a real-time communication session and another user can be on the other end of the real-time communication session, and the two users can send and receive text to and from each other in real time or near real time. The real-time communication sessions typically follow an agreed upon network protocol, and it can be difficult, if not impossible, to initiate a multitude of outbound instant communications and route the communications to different types of agents. Further, it is difficult, if not impossible, to use conventional communication systems to transfer communication sessions to different agents while making it appear to the end-user that he/she is speaking to the same agent the entire time.

To this end, an outbound instant messaging (IM) system can initiate a multitude of outbound invitations to a multitude of end-users. The invitations are user interface elements that are not part of actual communication sessions but have the look-and-feel of a chat window that is part of an active communication session. By not creating actual communication sessions and making the outbound invitations appear as if they are part of an already created communication sessions, network resources are saved. In particular, a communication session will be created only if an end-user responds to an outbound invitation. That is, communication sessions are not created for outbound invitations that receive no response, according to some example embodiments. As such, one or more of the methodologies described herein facilitate solving the technical problem of initiating automatic outbound instant messaging using a consistent virtual ID. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

Further, when an end-user responds to an outbound invitation, a chat window is displayed to the end-user that is part of the actual communication session. In some example embodiments, the outbound invitation and the subsequently created chat window have the same look and feel so that it appears to the end-user that he/she was always part of the newly created communication session. In some example embodiments, the outbound invitation and the chat window are different objects. That is, the outbound invitation is non-operable to connect to a communication session (e.g., it is a static image with a text field for inputs, but the text input into the field is not yet part of a session), and the chat window is a newly created, different object that is connected to the newly created communication session. In some alternative example embodiments, the outbound invitation is connectable to a communication session but is simply inactive. In these embodiments, when a communication session is created (e.g., in response to an end-user responding), the outbound invitation is activated by connecting it to the newly created communication session.

Further, according to some example embodiments, the same virtual agent identifier (“virtual ID”) is used throughout the communication session and in the outbound invitations. When a transfer from one agent to another agent occurs, the same virtual ID is used throughout the communication session so that the end-user is unaware that he/she has been transferred between agents. In some example embodiments, the virtual ID is a chat name displayed to the end-user. A real agent identifier of the real agent is kept as metadata to the communications sent between the end-user and agents. In some example embodiments, the agent identifier is stored as a header field or extension that is part of the communications (e.g., header data) but is not displayed to the end-user.

The outbound invitation may appear on a website the end-user is browsing or within an application (e.g., mobile app) the end-user is browsing or otherwise using. Display components on a client-side may be integrated into the website or application using a software development kit (SDK) or plug-in module so that the connection between the end-user and the agent does not need to go through third-party Application Programming Interfaces (APIs) or servers. In this way, the invitation, IM windows, the communication session, and the virtual ID can be handled from a back-end as part of a native solution that can allow easy transfers between agents.

To transfer between agents, a first agent triggers a user interface (UI) transfer menu and selects the new agent to transfer to, (i.e., the second agent). The first agent is disconnected from the communication session and the second agent is connected to the existing communication session to effectuate the transfer. The agent ID in the session metadata (e.g., header data) can be updated with the second agent's real ID, while the same virtual ID is displayed to the end-user.

The agents are network chat entities and can be human users or chat bots. In some example embodiments, a chat bot is selected automatically as the first agent to respond to a responding end-user. That is, when an end-user responds to an outbound invitation, a communication session is initiated, and the end-user can immediately communicate with a chat bot agent (e.g., an instantiation of a chat bot object class) that uses a virtual ID (e.g., “Sam”). A human agent user can then take over manually or automatically. When the human agent user takes over, the real agent ID of the agent is updated in metadata, but the same virtual ID (e.g., “Sam”) is displayed to the end user.

In some example embodiments, end-users to be sent outbound invitations can be selected beforehand from a customer database. For example, the outbound invitations can be sent to all customers that recently updated a piece of software or recently purchased an item on a website. Further, the time at which the outbound invitations are transmitted to the selected end-users can also be set beforehand.

As used herein, an “administrative user” is a person that sets up the invitations to be automatically transmitted (e.g., as part of an outbound message campaign), while an “agent user” is a person or chat bot that is part of an active communication session. However, it is appreciated that the same entity can be both. That is, the same user can set up the messages to be sent, and then, at a later time, when an end-user responds to an outbound invitation, the same user can reply to the end-user in an active communication session. Further, an agent can refer to the network chat entity that is conversing with the end-user. The end-user is the user (e.g., customer) operating a client device that receives and displays the outbound invitation.

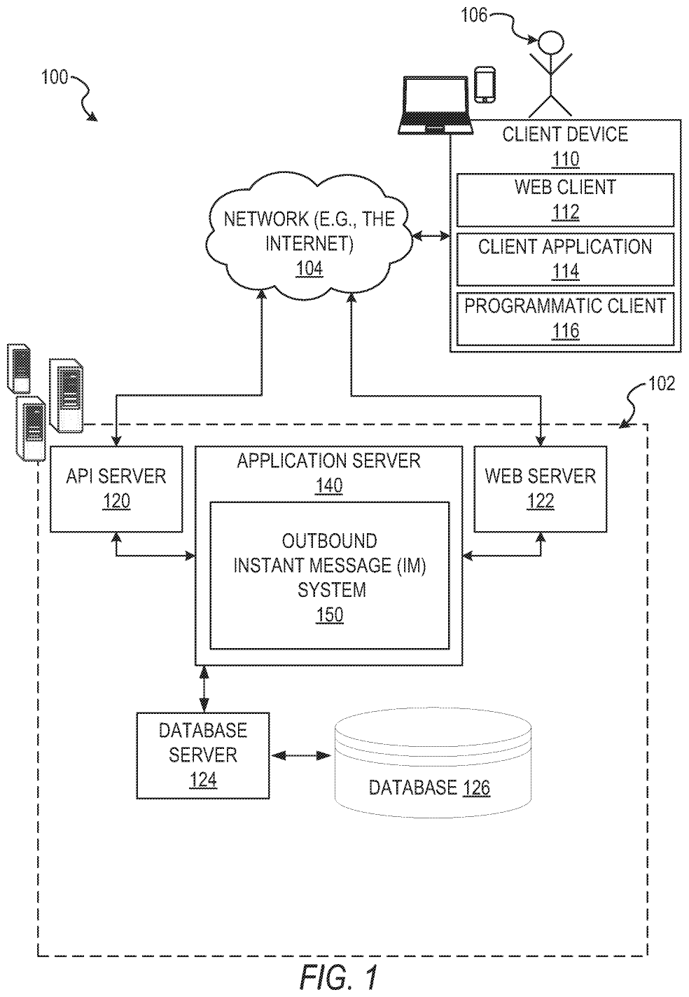

With reference to FIG. 1, an example embodiment of a high-level client-server-based network architecture 100 is shown. A networked system 102 provides server-side functionality via a network 104 (e.g., the Internet or wide area network (WAN)) to one or more client devices 110. In some implementations, a user (e.g., end-user 106) interacts with the networked system 102 using the client device 110. FIG. 1 illustrates, for example, a web client 112 (e.g., a browser), a client application 114, and a programmatic client 116 executing on the client device 110. The client device 110 includes the web client 112, the client application 114, and the programmatic client 116 alone, together, or in any suitable combination. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FIM network, a Worldwide Interoperability for Microwave Access (WiMax) network, another type of network, or any suitable combination thereof.

In some example embodiments, the client device 110 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps. In some implementations, the client application 114 includes various components operable to present information to the end-user 106 and communicate with networked system 102.

The web client 112 accesses the various systems of the networked system 102 via the web interface supported by a web server 122. Similarly, the programmatic client 116 and client application 114 accesses the various services and functions provided by the networked system 102 via the programmatic interface provided by an Application Program Interface (API) server 120.

Users (e.g., the end-user 106) comprise a person, a machine, or other means of interacting with the client device 110. In some example embodiments, the end-user 106 is not part of the network architecture 100, but interacts with the network architecture 100 via the client device 110 or another means. For instance, the end-user 106 provides input (e.g., touch screen input or alphanumeric input) to the client device 110 and the input is communicated to the networked system 102 via the network 104. In this instance, the networked system 102, in response to receiving the input from the end-user 106, communicates information to the client device 110 via the network 104 to be presented to the end-user 106. In this way, the end-user 106 can interact with the networked system 102 using the client device 110.

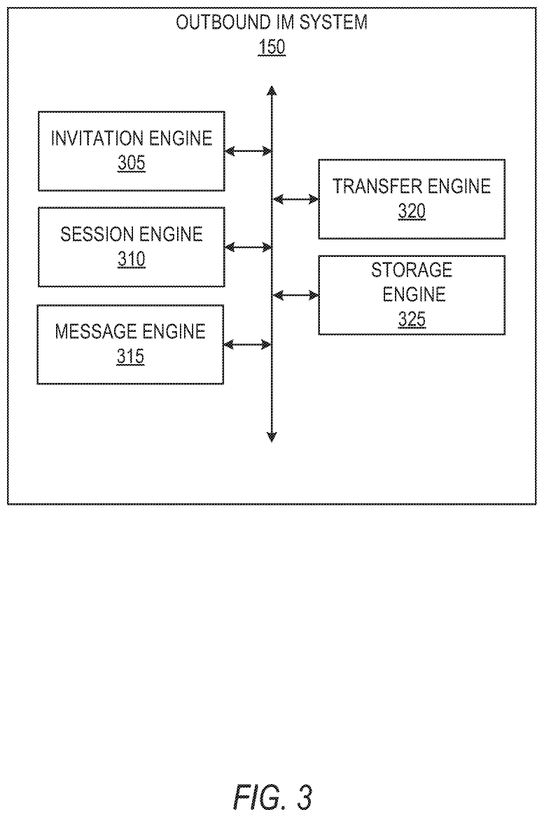

The API server 120 and the web server 122 are coupled to, and provide programmatic and web interfaces respectively to, one or more application server 140. The application server 140 can host an outbound instant message (IM) system 150, which comprises one or more modules or applications, each of which can be embodied as hardware, software, firmware, or any combination thereof. The outbound IM system 150 will be discussed in more detail in connection with FIG. 3. The application server 140 is, in turn, shown to be coupled to a database server 124 that facilitates access to one or more information storage repositories, such as database 126. In an example embodiment, the database 126 comprises one or more storage devices that store information to be accessed by the outbound IM system 150 or the client device 110.

Further, while the client-server-based network architecture 100 shown in FIG. 1 employs a client-server architecture, the present inventive subject matter is, of course, not limited to such an architecture, and can equally well find application in a distributed, or peer-to-peer, architecture system, for example. The various systems of the application server 140 (e.g., the outbound IM system 150) can also be implemented as standalone software programs, which do not necessarily have networking capabilities.

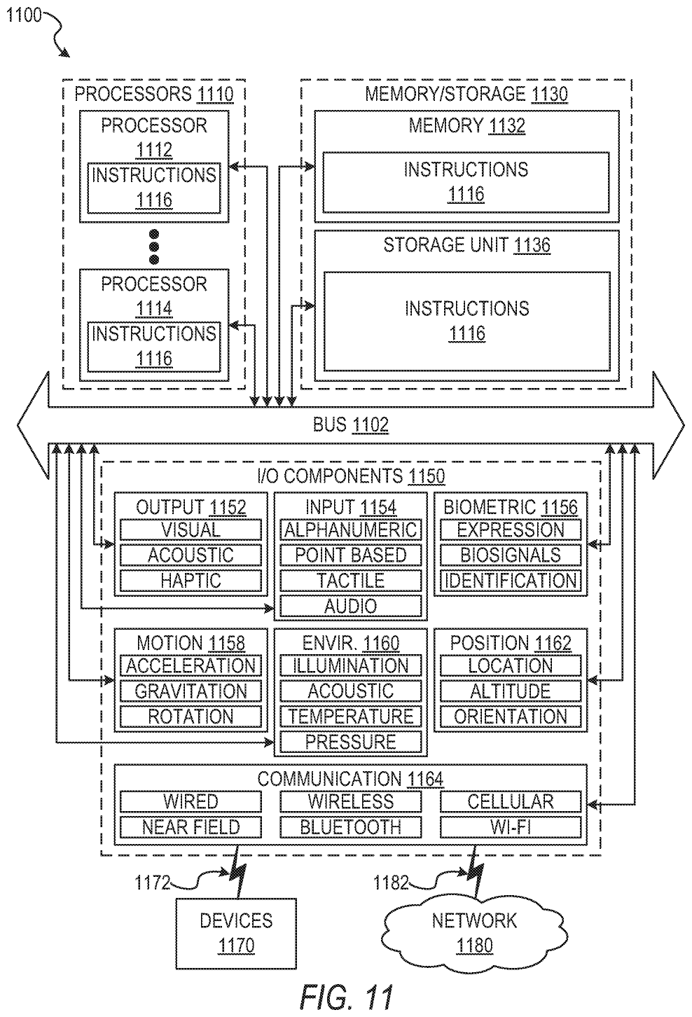

It is noted that the environment 100 shown in FIG. 1 is merely an example. For instance, any number and types of the user devices 106 may be embodied within the network architecture 100. Additionally, some components of the network architecture 100 may be combined. Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 11, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines. Moreover, any two or more of the systems or machines illustrated in FIG. 1 may be combined into a single system or machine, and the functions described herein for any single system or machine may be subdivided among multiple systems or machines.

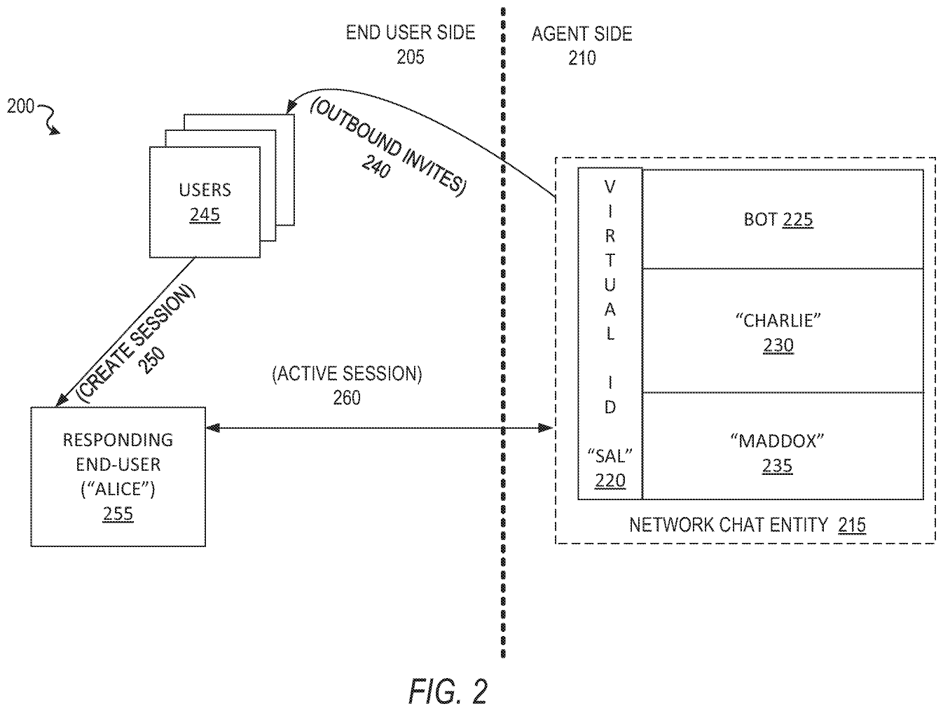

FIG. 2 shows a high-level network architecture 200 of the outbound IM system 150 implementing outbound invitations, according to some example embodiments. In the high-level network architecture 200, there is an end-user side 205 (e.g., “client side” accessed from a web browser or application), and agent side 210 (e.g., “backend,” accessed by agent client devices or applications hosted from the application server 140). A network chat entity 215 corresponds to an agent user and the outbound IM system 150 that sends outbound invitations 240 and responds to users 245 in created communication sessions. The users 245 (e.g., client devices of the users) receive and display the outbound invitations 240. When a user 245 responds to the outbound invitation 240, a communication session is created at operation 250. The user, now a responding end-user 255, can then communicate with the network chat entity 215 over an active session 260. Communications sent from the network chat entity 215 are labeled as having been sent from a virtual ID 220 (e.g., a virtual user named “Sal”). The actual entity inputting responses for the network chat entity 215 can be different agents, such as a bot 225 (e.g., a chatbot), Charlie 230 (e.g., a human agent user), and Maddox 235 (e.g., a human agent user). The agent identifiers for the agents 225-235 may be stored in metadata of the communications sent over the active session 260 (e.g., as packet header data, header fields).

FIG. 3 shows example functional components of the outbound IM system 150, according to some example embodiments. The components themselves are communicatively coupled (e.g., via appropriate interfaces) to each other and to various data sources, so as to allow information to be passed between the applications or so as to allow the applications to share and access common data. Furthermore, the components access the database 126 via the database server 124. As illustrated, the outbound IM system 150 comprises an invitation engine 305, a session engine 310, a message engine 315, a transfer engine 320, and a storage engine 325.

The invitation engine 305 manages generating the invitations according to parameters established by an administrative user. The invitation engine 305 further manages transmitting the invitations to specified end-users. A client-side instance of the invitation engine 305 receives and displays the invitations on client devices (e.g., laptops, smartphones) of the end-users.

The session engine 310 is configured to receive end-user interactions from the end-users and establish communication sessions between the end-users and network chat entities (e.g., a human agent, a chat bot).

The message engine 315 is configured to send and receive real-time communications over the created sessions. The message engine 315 is configured to show messages sent from the network chat entity from a consistent virtual ID and include the identify of the actual agent (e.g., a human user or chat bot) as message metadata, as discussed in further details below. A client-side instance of the message engine 315 can be integrated into a website or app of the end-user's client device to display messages (e.g., through a chat window), while a server side instance of the message engine 315 can display messages on a client device of the network chat entity (e.g., a desktop computer being used by a human agent). According to some example embodiments, the message engine 315 further manages receiving text input into a text field area and sending the text as real-time communication messages over a session.

The transfer engine 320 manages receiving an instruction from an agent to transfer the session to another agent. The transfer engine 320 further manages the transfer of the communication session between agents, as discussed in further details below.

The storage engine 325 manages storing a text record of messages sent over a given session. The text record created by the storage engine 325 can indicate who the end-user is, messages sent by the end-user, who the network chat entity is, what the virtual consistent ID is, transfer events between network chat entities, and messages sent by the one or more network chat entities that connected to a given session.

Any one or more of the components (e.g., engines) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that component. Accordingly, different components described herein may include and configure different arrangements of the processors at different points in time or a single arrangement of the processors at different points in time. Each component (e.g., engine) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices. The outbound IM system 150 may comprise other components not pertinent to example embodiments that are not shown or discussed.

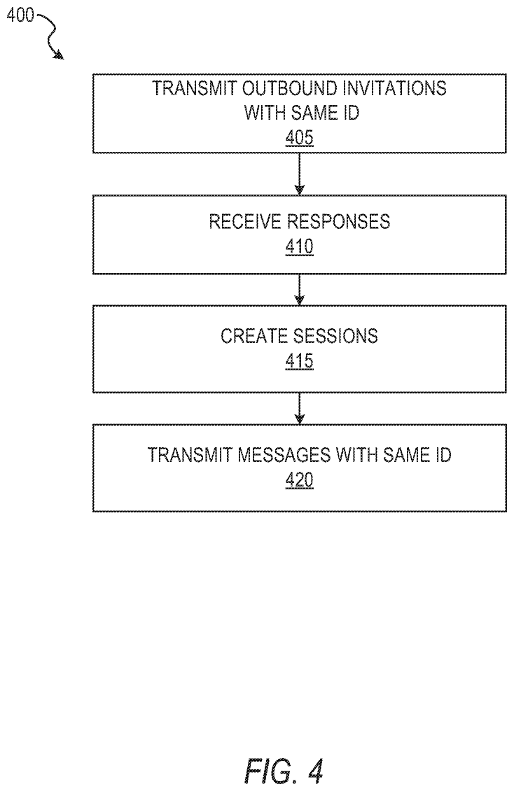

FIG. 4 shows a flow diagram of a method 400 for implementing the outbound IM system 150 with consistent virtual IDs, according to some example embodiments. Operations in the method 400 may be performed by the outbound IM system 150, using components (e.g., engines) described above with respect to FIG. 3. Accordingly, the method 400 is described by way of example with reference to the outbound IM system 150. However, it shall be appreciated that at least some of the operations of the method 400 may be deployed on various other hardware configurations or be performed by similar components residing elsewhere. Therefore, the method 400 is not intended to be limited to the outbound IM system 150.

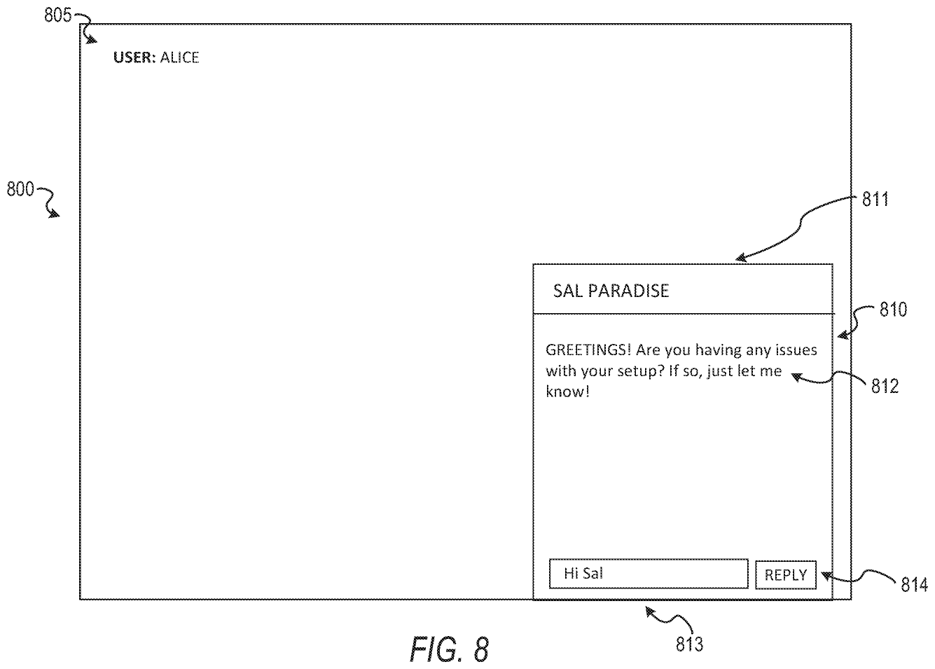

At operation 405, the invitation engine 305 generates and transmits a plurality of outbound invitations to a plurality of client devices. The client devices may be end-user computer devices, such as client devices 110. The outbound invitations are not part of existing communication sessions, but are rather user interface elements that are configured to look like they are part of existing communication sessions. An example of an outbound invitation is displayed in FIG. 8 with further discussion below.

At operation 410, the session engine 310 receives a one or more responses based on the outbound invitations. For example, an end-user may input text into a text entry field of one of the outbound invitations. The session engine 310 receives the text that is input into the outbound invitation user interface element and automatically creates a real-time communication session (e.g., IM channel) in response, at operation 415.

The real-time communication session can then be used by an agent to further communicate with the responding end-user. Further, the session engine 310 creates an instant message chat window for display on the responding end-user's user interface. The instant message chat window is an interface to the real-time communication session for the end-user. The instant message chat window can be modeled to look the same as the outbound invitation user interface element, according to some example embodiments. In this way, from the end-user's viewpoint, the outbound invitation and the actual instant message chat window appear as being the same display element, though they are different objects (e.g., the outbound invitation is not part of a real communication session while the instant message chat window is part of the real communication session created in response to the end-user interacting with the outbound invitation). Further, the outbound invitation and the instant message chat window both indicate that the end-user is communicating with the same virtual ID, according to some example embodiments. That is, the outbound invitation appears to be sent from a virtual ID of an agent (e.g., “Sam”), and the instant message chat window also indicates that it is sent from the same virtual ID (e.g., “Sam”).

At operation 420, the message engine 315 transmits messages from the agent user to the end-user using the created communication session. The same virtual ID may be used for all users that respond to the outbound invitations. In the event that a plurality of communication sessions have been created in response to a plurality of users responding to the outbound invitations, different communication sessions may be routed to different agent users, but each of the agent users can use the same virtual ID.

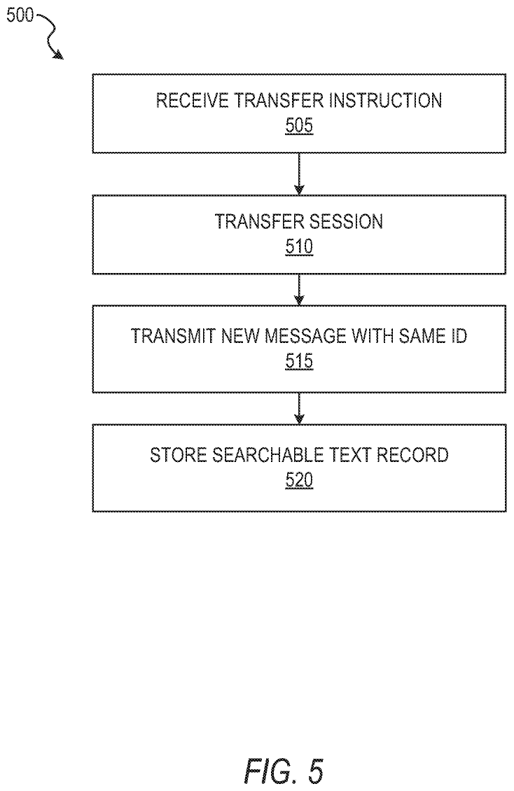

FIG. 5 shows a flow diagram of a method 500 for transferring and storing outbound communications, according to some example embodiments. Operations in the method 500 may be performed by the outbound IM system 150, using components (e.g., engines) described above with respect to FIG. 3. Accordingly, the method 500 is described by way of example with reference to the outbound IM system 150. However, it shall be appreciated that at least some of the operations of the method 500 may be deployed on various other hardware configurations or be performed by similar components residing elsewhere. Therefore, the method 500 is not intended to be limited to the outbound IM system 150.

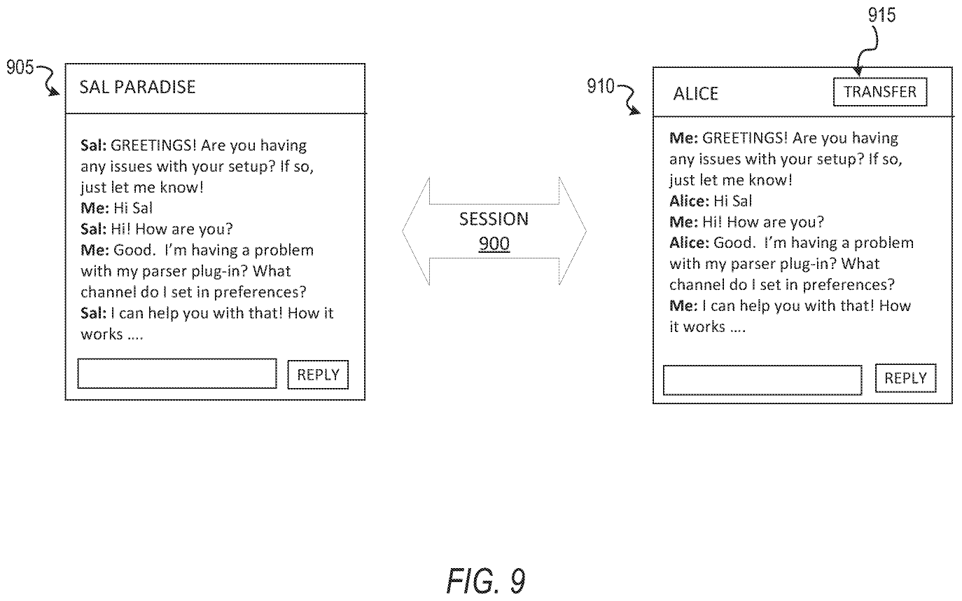

At operation 505, the transfer engine 320 receives an instruction to transfer the session from a first agent to a second agent. For example, the first agent can select a user interface transfer button that initiates a pop-up menu displaying agents to which the session can be transferred. The first agent can then select the second agent, as discussed in further detail below with reference to FIG. 9.

At operation 510, the transfer engine 320 transfers the session from the first agent to the second agent. According to some example embodiments, the transfer engine 320 transfers a session by first terminating the first agent connection to the session and then creating a connection between the second agent and the communication session.

At operation 515, the message engine 315 transmits a real-time message from the second agent to the end-user using the same virtual ID. From the end-user's perspective, it appears that the end-user is communicating with the same entity the entire time, and the end-user is unaware that the communication session transferred from the first agent to the second agent.

At operation 520, the storage engine 325 stores a searchable text record of the communications in the communication session for later analysis. For example, after the end-user exits (e.g., terminates, closes) the chat window, the communication session is terminated. The communication session terminating may activate the storage engine 325, which then stores the communications of the communication session for later analysis. In some example embodiments, the text record further indicates transfer events between agents.

An example of a text record of session communications may be as follows:

Record Start
Sal (Session Invitation using virtual ID “Sal”): GREETINGS! Are you having any issues with your setup? If so, just let me know!
Alice (End-user): Hi Sal

—Communication Session Start: Virtual ID: “Sal”, Agent ID: “Charlie”—
Sal (Charlie): Hi! How are you?
Alice (End-user): Good. I′m having a problem with my parser plug-in.
What channel do I set in preferences?

—Transfer Session: Virtual ID: “Sal”, Agent ID: “Bob”—
Sal (Bob): I can help you with that! How it works is
Record End

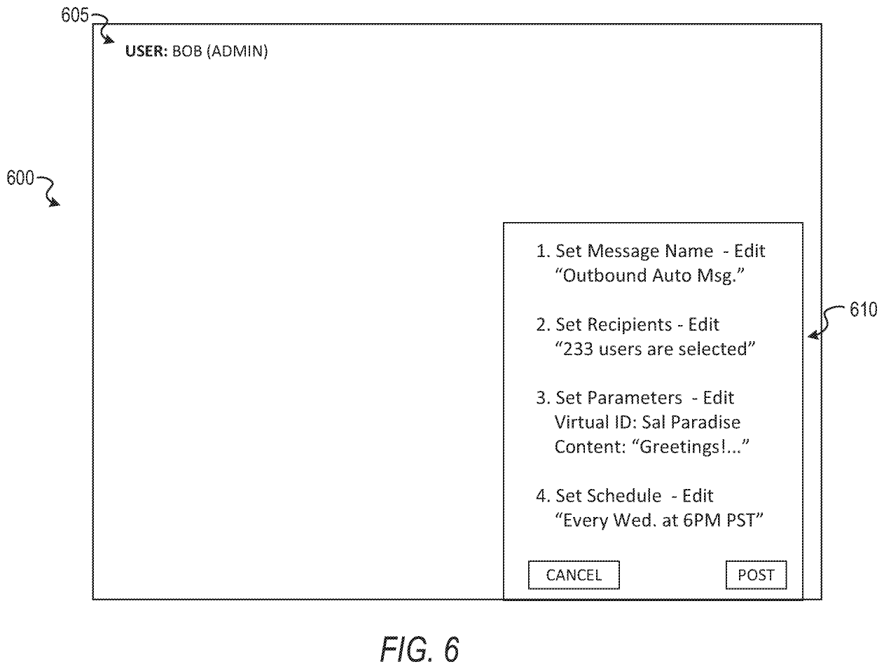

FIG. 6 shows a user interface for setting up outbound invitations using the outbound IM system 150, according to some example embodiments. The administrative user interface 600 can be generated by the invitation engine 305 on the agent side 210, according to some example embodiments. The administrative user interface 600 can be displayed on a client device operated by an administrative user, such as the administrative user “Bob” as illustrated by indicator 605. The administrative user interface 600 can include an outbound setup window 610. The outbound setup window 610 includes various elements to configure parameters of an outgoing invitation. For example, the outbound setup window 610 may include a first “Set Message Name” area for editing a message name, which can be a campaign name or project name for a set of outbound IMs to be sent. The outbound setup window 610 further includes a second “Set Recipients” area for selecting which users should receive the outbound invitations. The outbound setup window 610 further includes a third “Set Parameters” area in which a virtual ID is selected and the content for the outbound invitation can be input. The outbound setup window 610 further includes a fourth “Set Schedule” area, which is used for scheduling a one-time or periodic transmission of the outbound invitations.

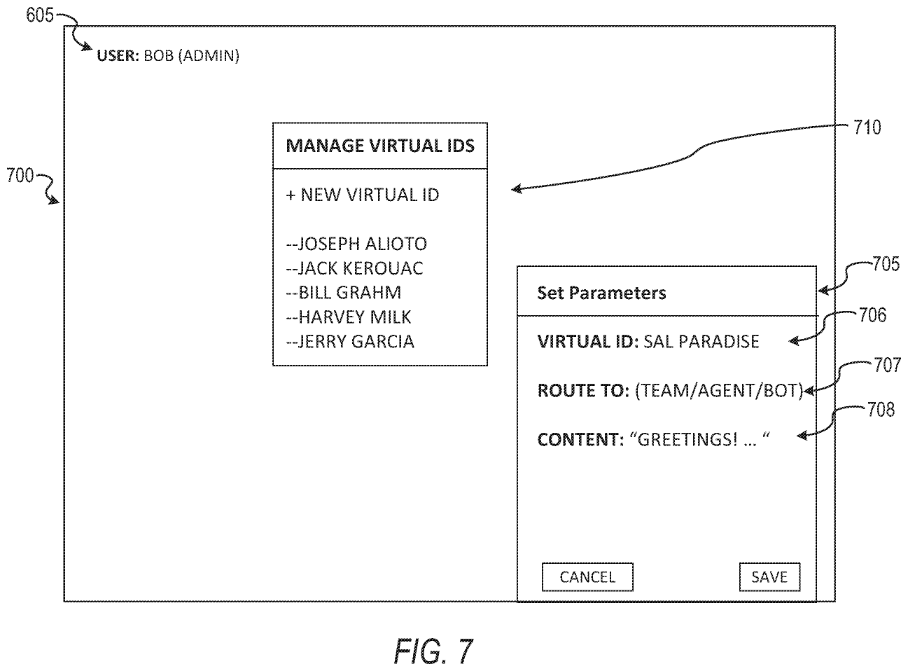

FIG. 7 shows an administrative user interface 700 for editing message content and other outbound message parameters, according to some example embodiments. The administrative user interface 600 can be generated by the invitation engine 305 on the agent side 210, according to some example embodiments. The administrative user interface 700 may be displayed in response to the administrative user (e.g., Bob) selecting an edit link in the third “Set Parameters” area in the outbound setup window 610 (FIG. 6). As illustrated, in response to the user selecting the edit link, a parameter configuration window 705 is displayed within the administrative user interface 700. The parameter configuration window 705 includes a virtual ID link 706 to set the virtual ID for the outbound communications, a route to link 707 to set which agents a responding user should be routed to, and a content link 708 for inputting text to be sent as content of the outbound invitations. In the example illustrated in FIG. 7, the administrative user Bob has selected the virtual ID link 706 and a virtual ID window 710 is displayed in response to Bob selecting the virtual ID link 706. The virtual ID window 710 allows the administrative user to select a virtual ID for the outbound invitations.

FIG. 8 shows an end-user user interface 800 displaying an outbound invitation 810, according to some example embodiments. The end-user user interface 800 can be generated by the invitation engine 305 on the client side 205, according to some example embodiments. The end-user interface 800 can be displayed as part of an active end-user session as indicated by indicator 805. In the present example, the indicator 805 indicates that an end-user is Alice, an end-user browsing a website or browsing an app. While the end user is browsing, an outbound invitation 810 pops up in a lower right-hand corner of the end-user interface 800, according to some example embodiments. Although the outbound invitation 810 appears to be part of a chat session, the chat session has not yet been created. Instead, the outbound invitation 810 is an arrangement of user interface elements, such as a text header 811 displaying the virtual ID of “Sal Paradise,” a content area 812, a text input area 813, and a reply button 814. The end-user Alice can input text into the text input area 813 and select the reply button 814. In response to the reply button 814 being selected, the communication session is created and an agent is connected to Alice (e.g., on the other end of the communication session).

FIG. 9 shows a real-time communication channel between an end-user and an agent set up by the outbound IM system 150, according to some example embodiments. Continuing the example above, in response to the user Alice entering text into the text input area 813 and selecting the reply button 814, a communication session 900 is created between the end-user and an agent by the session engine 310. Chat windows may be created for each participant. For example, a client instant message window 905 is displayed on a display of the end-user's client device (e.g., displayed by a message engine 315 installed on the client side 205), and an agent instant message window 910 is displayed on the agent's display (e.g., displayed by a message engine 315 installed on the agent side 210). In some example embodiments, the outbound invitation 810 (which is not connected to an active session) and the client instant message window 905 (which is connected to the active session) are configured to have the same look and feel. This gives the end-user the impression that they have been connected to an active session at the time when the outbound invitation 810 initially popped up on the end-user interface 800. As illustrated in FIG. 9, the agent instant message window 910 further includes a transfer button 915 for transferring the session created for Alice to a different agent.

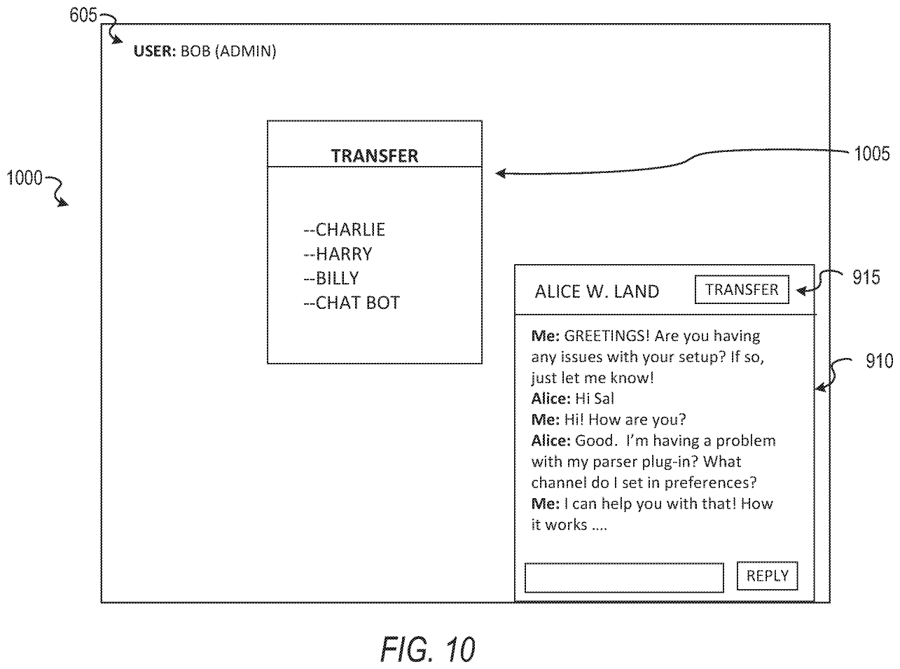

FIG. 10 shows an administrative user interface 1000 for transferring communication sessions, according to some example embodiments. The administrative user interface 1000 can be created by the message engine 315, which can transfer control the transfer engine 320 to perform the transfer operations. Continuing the example above, assume that the agent user Bob has selected the transfer button 915 of the agent instant message window 910. Responsive to the transfer button 915 being selected, a transfer selection window 1005 pops up within the administrative user interface 1000. The agent user Bob can then select an agent to transfer Alice's session to. For example, the agent user Bob can select “Charlie” within the transfer selection window 1005 and the communication session is transferred to the agent user Charlie as discussed above. Likewise, the agent user Bob can select “Chat Bot” and the communication session will be transferred to a chat bot. As discussed, in either case (e.g., Charlie or Chat Bot), the virtual ID is “Sal Paradise” selected from the set parameter configuration window 705 (FIG. 7).

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIGS. 1-10 are implemented in some embodiments in the context of a machine and an associated software architecture. The sections below describe representative software architecture and machine (e.g., hardware) architecture that are suitable for use with the disclosed embodiments.

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein can be executed. For example, the instructions 1116 can cause the machine 1100 to execute the operations of FIG. 2 and the flow diagrams of FIGS. 4 and 5. Additionally, or alternatively, the instructions 1116 can implement the engines of FIG. 3, and so forth. The instructions 1116 transform the general, non-programmed machine into a particular machine programmed to carry out the described and illustrated functions in the manner described. In alternative embodiments, the machine 1100 operates as a standalone device or can be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 can include processors 1110, memory/storage 1130, and I/O components 1150, which can be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1112 and processor 1114 that may execute instructions 1116. The term “processor” is intended to include multi-core processor that may comprise two or more independent processors (sometimes referred to as “cores”) that can execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory/storage 1130 can include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 can also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of the processors 1110 are examples of machine-readable media.

As used herein, the term “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 can include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 can include many other components that are not shown in FIG. 11. The I/O components 1150 are grouped according to functionality merely for simplifying the following discussion, and the grouping is in no way limiting. In various example embodiments, the I/O components 1150 can include output components 1152 and input components 1154. The output components 1152 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 1150 can include biometric components 1156, motion components 1158, environmental components 1160, or position components 1162, among a wide array of other components. For example, the biometric components 1156 can include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 can include acceleration sensor components (e.g., an accelerometer), gravitation sensor components, rotation sensor components (e.g., a gyroscope), and so forth. The environmental components 1160 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1162 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 include a network interface component or other suitable device to interface with the network 1180. In further examples, communication components 1164 include wired communication components, wireless communication components, cellular communication components, Near Field Communication (NFC) components, BLUETOOTH® components (e.g., BLUETOOTH® Low Energy), WI-FI® components, and other communication components to provide communication via other modalities. The devices 1170 may be another machine or any of a wide variety of peripheral devices (e.g., a peripheral device coupled via a Universal Serial Bus (USB)).

Moreover, the communication components 1164 can detect identifiers or include components operable to detect identifiers. For example, the communication components 1164 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1164, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1180 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or other type of cellular or wireless coupling. In this example, the coupling 1182 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 can be transmitted or received over the network 1180 using a transmission medium via a network interface device (e.g., a network interface component included in the communication components 1164) and utilizing any one of a number of well-known transfer protocols (e.g., Hypertext Transfer Protocol (HTTP)). Similarly, the instructions 1116 can be transmitted or received using a transmission medium via the coupling 1172 (e.g., a peer-to-peer coupling) to devices 1170. The term “transmission medium” shall be taken to include any intangible medium that is capable of storing, encoding, or carrying the instructions 1116 for execution by the machine 1100, and includes digital or analog communications signals or other intangible medium to facilitate communication of such software.

### EXAMPLES

Example 1 is a method for implementing automatic instant messages. The method comprises generating, by an outbound instant message (IM) system, a plurality of real-time electronic message invitations that each have the look-and-feel of a message window connected to real-time communication session, the plurality of real-time electronic message invitations not being connected to the real-time communication session; transmitting, by the outbound IM system, the plurality of real-time electronic message invitations to a plurality of client devices, the plurality of real-time electronic message invitations indicating that the plurality of real-time electronic message invitations are sent from an entity using a virtual identifier (ID); receiving, by the outbound IM system, a response to one of the plurality of real-time electronic message invitations; in response to receiving the responses, initiating, by the outbound IM system, a session between a client device that generated the response and a network chat entity, the session being a real-time electronic communication session; transmitting, to the client device using the session, a real-time message from the network chat entity, the real-time message being displayed in a message window that is an active version of one of the plurality of real-time message invitations, the message window including an indication that the real-time message was sent from the entity identified by the virtual ID.

In example 2, the subject matter of example 1 can optionally include receiving, by the outbound IM system, an additional response to another of the plurality of real-time electronic message invitations; in response to receiving the additional response, initiating, by the outbound IM system, an additional session between an additional client device that generated the additional response and an additional network chat entity, the additional session being a real-time message session; and transmitting, from the additional network chat entity to the additional client device using the additional session, an additional real-time message configured to display, on the additional client device, an additional indication that the additional real-time message was sent from the entity identified by the virtual ID.

In example 3, the subject matter of example 1-2 can optionally include wherein the real-time message comprises metadata storing an agent identifier identifying the network chat entity, the agent identifier being different from the virtual ID.

In example 4, the subject matter of example 1-3 can optionally include wherein the agent identifier is not displayed to the client device.

In example 5, the subject matter of example 1-4 can optionally include receiving, from a user interface operable by the network chat entity, an instruction to transfer the session to a further network chat entity; and responsive to receiving the instruction, transferring the session to the further network chat entity, the transferring comprising disconnecting the network chat entity from the session and connecting the further network chat entity to the session.

In example 6, the subject matter of example 1-5 can optionally include transmitting, via the session, a further real-time message from the further network chat entity, the further real-time message configured to display, on the client device, an indication that the further real-time message was sent from the entity identified by the virtual ID.

In example 7, the subject matter of example 1-6 can optionally include wherein the further real-time message comprises further metadata storing a further agent identifier identifying the further network chat entity, the further agent identifier being different from the virtual ID.

In example 8, the subject matter of example 1-7 can optionally include wherein the further identifier is not displayed to the client device.

In example 9, the subject matter of example 1-8 can optionally include wherein the metadata is one or more packet header data values.

In example 10, the subject matter of example 1-9 can optionally include wherein the network chat entity is configured for chat bot input and the further network chat entity is configured for human text input.

In example 11, the subject matter of example 1-10 can optionally include storing a text record of communications of the session, the communications including at least the real-time message and the further real-time message, wherein the text record includes an indication of a transfer event that indicates the transfer from the network chat entity to the further network chat entity.

Example 11 is a system for implementing automatic outbound instant messages. The system comprises one or more processors of a machine; and a memory storing instructions that, when executed by the one or more processors, cause the machine to perform operations comprising: generating, by an outbound instant message (IM) system, a plurality of real-time electronic message invitations that each have the look-and-feel of a message window connected to real-time communication session, the plurality of real-time electronic message invitations not being connected to the real-time communication session; transmitting, by the outbound IM system, the plurality of real-time electronic message invitations to a plurality of client devices, the plurality of real-time electronic message invitations indicating that the plurality of real-time electronic message invitations are sent from an entity using a virtual identifier (ID); receiving, by the outbound IM system, a response to one of the plurality of real-time electronic message invitations; in response to receiving the responses, initiating, by the outbound IM system, a session between a client device that generated the response and a network chat entity, the session being a real-time electronic communication session; transmitting, to the client device using the session, a real-time message from the network chat entity, the real-time message being displayed in a message window that is an active version of one of the plurality of real-time message invitations, the message window including an indication that the real-time message was sent from the entity identified by the virtual ID.

In example 12, the subject matter of example 11 can optionally include further operations comprising receiving, by the outbound IM system, an additional response to another of the plurality of real-time electronic message invitations; in response to receiving the additional response, initiating, by the outbound IM system, an additional session between an additional client device that generated the additional response and an additional network chat entity, the additional session being a real-time message session; and transmitting, from the additional network chat entity to the additional client device using the additional session, an additional real-time message configured to display, on the additional client device, an additional indication that the additional real-time message was sent from the entity identified by the virtual ID.

In example 13, the subject matter of example 1-12 can optionally include wherein the real-time message comprises metadata storing an agent identifier identifying the network chat entity, the agent identifier being different from the virtual ID.

In example 14, the subject matter of example 1-13 can optionally include wherein the agent identifier is not displayed to the client device.

In example 15, the subject matter of example 1-14 can optionally include further operations comprising receiving, from a user interface operable by the network chat entity, an instruction to transfer the session to a further network chat entity; and responsive to receiving the instruction, transferring the session to the further network chat entity, the transferring comprising disconnecting the network chat entity from the session and connecting the further network chat entity to the session.

In example 16, the subject matter of example 1-15 can optionally include further operations comprising transmitting, via the session, a further real-time message from the further network chat entity, the further real-time message configured to display, on the client device, an indication that the further real-time message was sent from the entity identified by the virtual ID.

In example 17, the subject matter of example 1-16 can optionally include wherein the further real-time message comprises further metadata storing a further agent identifier identifying the further network chat entity, the further agent identifier being different from the virtual ID.

In example 18, the subject matter of example 1-17 can optionally include wherein the further identifier is not displayed to the client device.

In example 19, the subject matter of example 1-18 can optionally include wherein the metadata is one or more packet header data values.

In example 20, the subject matter of example 1-19 can optionally include wherein the network chat entity is configured for chat bot input and the further network chat entity is configured for human text input.

In example 21, the subject matter of example 1-20 can optionally include further operations comprising storing a text record of communications of the session, the communications including at least the real-time message and the further real-time message, wherein the text record includes an indication of a transfer event that indicates the transfer from the network chat entity to the further network chat entity.

Example 22 is a machine storage medium for implementing automatic outbound instant messages. The machine storage medium comprises instructions that, when executed by one or more hardware processors of a machine, cause the machine to perform operations comprising: generating, by an outbound instant message (IM) system, a plurality of real-time electronic message invitations that each have the look-and-feel of a message window connected to real-time communication session, the plurality of real-time electronic message invitations not being connected to the real-time communication session; transmitting, by the outbound IM system, the plurality of real-time electronic message invitations to a plurality of client devices, the plurality of real-time electronic message invitations indicating that the plurality of real-time electronic message invitations are sent from an entity using a virtual identifier (ID); receiving, by the outbound IM system, a response to one of the plurality of real-time electronic message invitations; in response to receiving the responses, initiating, by the outbound IM system, a session between a client device that generated the response and a network chat entity, the session being a real-time electronic communication session; transmitting, to the client device using the session, a real-time message from the network chat entity, the real-time message being displayed in a message window that is an active version of one of the plurality of real-time message invitations, the message window including an indication that the real-time message was sent from the entity identified by the virtual ID.

In example 23, the subject matter of example 22 can optionally include further operations comprising receiving, by the outbound IM system, an additional response to another of the plurality of real-time electronic message invitations; in response to receiving the additional response, initiating, by the outbound IM system, an additional session between an additional client device that generated the additional response and an additional network chat entity, the additional session being a real-time message session; and transmitting, from the additional network chat entity to the additional client device using the additional session, an additional real-time message configured to display, on the additional client device, an additional indication that the additional real-time message was sent from the entity identified by the virtual ID.

In example 24, the subject matter of example 1-23 can optionally include wherein the real-time message comprises metadata storing an agent identifier identifying the network chat entity, the agent identifier being different from the virtual ID.

In example 25, the subject matter of example 1-24 can optionally include wherein the agent identifier is not displayed to the client device.

In example 26, the subject matter of example 1-25 can optionally include further operations comprising receiving, from a user interface operable by the network chat entity, an instruction to transfer the session to a further network chat entity; and responsive to receiving the instruction, transferring the session to the further network chat entity, the transferring comprising disconnecting the network chat entity from the session and connecting the further network chat entity to the session.

In example 27, the subject matter of example 1-26 can optionally include further operations comprising transmitting, via the session, a further real-time message from the further network chat entity, the further real-time message configured to display, on the client device, an indication that the further real-time message was sent from the entity identified by the virtual ID.

In example 28, the subject matter of example 1-27 can optionally include wherein the further real-time message comprises further metadata storing a further agent identifier identifying the further network chat entity, the further agent identifier being different from the virtual ID.

In example 29, the subject matter of example 1-28 can optionally include wherein the further identifier is not displayed to the client device.

In example 30, the subject matter of example 1-29 can optionally include wherein the metadata is one or more packet header data values.

In example 31, the subject matter of example 1-30 can optionally include wherein the network chat entity is configured for chat bot input and the further network chat entity is configured for human text input.

In example 32, the subject matter of example 1-31 can optionally include further operations comprising storing a text record of communications of the session, the communications including at least the real-time message and the further real-time message, wherein the text record includes an indication of a transfer event that indicates the transfer from the network chat entity to the further network chat entity.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
generating, by an outbound instant message (IM) system, a plurality of real-time electronic message invitations that each have the look-and-feel of a message window connected to a real-time communication session, the plurality of real-time electronic message invitations not being connected to the real-time communication session;
transmitting, by the outbound IM system, the plurality of real-time electronic message invitations to a plurality of client devices, the plurality of real-time electronic message invitations indicating that the plurality of real-time electronic message invitations are sent from an entity using a virtual identifier (ID);
receiving, by the outbound IM system, a response to one of the plurality of real-time electronic message invitations;
in response to receiving the response, initiating, by the outbound IM system, a session between a client device that generated the response and a network chat entity, the session being a real-time electronic communication session;
transmitting, to the client device using the session, a real-time message from the network chat entity, the real-time message being displayed in a message window that is an active version of one of the plurality of real-time message invitations, the message window including an indication that the real-time message was sent from the entity identified by the virtual ID.

2. The method of claim 1, further comprising:
receiving, by the outbound IM system, an additional response to another of the plurality of real-time electronic message invitations;
in response to receiving the additional response, initiating, by the outbound IM system, an additional session between an additional client device that generated the additional response and an additional network chat entity, the additional session being a real-time communication message session; and
transmitting, to the additional client device using the additional session, an additional real-time message from the additional network chat entity, the additional real-time message being displayed in an additional message window that is an additional active version of one of the plurality of real-time message invitations, the additional message window including an additional indication that the additional real-time message was sent from the entity identified by the virtual ID.

3. The method of claim 1, wherein the real-time message comprises metadata storing an agent identifier identifying the network chat entity, the agent identifier being different from the virtual ID.

4. The method of claim 3, wherein the agent identifier is not displayed to the client device.

5. The method of claim 1, further comprising:
receiving, from a user interface operable by the network chat entity, an instruction to transfer the session to a further network chat entity; and
responsive to receiving the instruction, transferring the session to the further network chat entity, the transferring comprising disconnecting the network chat entity from the session and connecting the further network chat entity to the session.

6. The method of claim 5, further comprising:
transmitting, via the session, a further real-time message from the further network chat entity, the further real-time message configured to display, on the client device, an indication that the further real-time message was sent from the entity identified by the virtual ID.

7. The method of claim 6, wherein the further real-time message comprises further metadata storing a further agent identifier identifying the further network chat entity, the further agent identifier being different from the virtual ID.

8. The method of claim 7, wherein the further agent identifier is not displayed to the client device.

9. The method of claim 3, wherein the metadata is one or more packet header data values.

10. The method of claim 5, wherein the network chat entity is configured for chat bot input and the further network chat entity is configured for human text input.

11. The method of claim 7, further comprising:
storing a text record of communications of the session, the communications including at least the real-time message and the further real-time message, wherein the text record includes an indication of a transfer event that indicates the transfer from the network chat entity to the further network chat entity.

12. A system comprising:
one or more processors of a machine; and
a memory storing instructions that, when executed by the one or more processors, cause the machine to perform operations comprising:
generating, by an outbound instant message (IM) system, a plurality of real-time electronic message invitations that each have the look-and-feel of a message window connected to a real-time communication session, the plurality of real-time electronic message invitations not being connected to the real-time communication session;
transmitting, by the outbound IM system, the plurality of real-time electronic message invitations to a plurality of client devices, the plurality of real-time electronic message invitations indicating that the plurality of real-time electronic message invitations are sent from an entity using a virtual identifier (ID);
receiving, by the outbound IM system, a response to one of the plurality of real-time electronic message invitations;
in response to receiving the response, initiating, by the outbound IM system, a session between a client device that generated the response and a network chat entity, the session being a real-time electronic communication session;
transmitting, to the client device using the session, a real-time message from the network chat entity, the real-time message being displayed in a message window that is an active version of one of the plurality of real-time message invitations, the message window including an indication that the real-time message was sent from the entity identified by the virtual ID.

13. The system of claim 12, the operations further comprising:
receiving, by the outbound IM system, an additional response to another of the plurality of real-time electronic message invitations;
in response to receiving the additional response, initiating, by the outbound IM system, an additional session between an additional client device that generated the additional response and an additional network chat entity, the additional session being a real-time communication message session; and
transmitting, to the additional client device using the additional session, an additional real-time message from the additional network chat entity, the additional real-time message being displayed in an additional message window that is an additional active version of one of the plurality of real-time message invitations, the additional message window including an additional indication that the additional real-time message was sent from the entity identified by the virtual ID.

14. The system of claim 12, wherein the real-time message comprises metadata storing an agent identifier identifying the network chat entity, the agent identifier being different from the virtual ID.

15. The system of claim 14, wherein the agent identifier is not displayed to the client device.

16. The system of claim 12, the operations further comprising:
receiving, from a user interface operable by the network chat entity, an instruction to transfer the session to a further network chat entity; and
responsive to receiving the instruction, transferring the session to the further network chat entity, the transferring comprising disconnecting the network chat entity from the session and connecting the further network chat entity to the session.

17. The system of claim 16, the operations further comprising:
transmitting, via the session, a further real-time message from the further network chat entity, the further real-time message configured to display, on the client device, an indication that the further real-time message was sent from the entity identified by the virtual ID.

18. The system of claim 17, wherein the further real-time message comprises further metadata storing a further agent identifier identifying the further network chat entity, the further agent identifier being different from the virtual ID.

19. A machine-storage medium embodying instructions that, when executed by one or more hardware processors of a machine, cause the machine to perform operations comprising:
generating, by an outbound instant message (IM) system, a plurality of real-time electronic message invitations that each have the look-and-feel of a message window connected to a real-time communication session, the plurality of real-time electronic message invitations not being connected to the real-time communication session;
transmitting, by the outbound IM system, the plurality of real-time electronic message invitations to a plurality of client devices, the plurality of real-time electronic message invitations indicating that the plurality of real-time electronic message invitations are sent from an entity using a virtual identifier (ID);
receiving, by the outbound IM system, a response to one of the plurality of real-time electronic message invitations;
in response to receiving the response, initiating, by the outbound IM system, a session between a client device that generated the response and a network chat entity, the session being a real-time electronic communication session;
transmitting, to the client device using the session, a real-time message from the network chat entity, the real-time message being displayed in a message window that is an active version of one of the plurality of real-time message invitations, the message window including an indication that the real-time message was sent from the entity identified by the virtual ID.

20. The machine-storage medium of claim 19, wherein the real-time message comprises metadata storing an agent identifier identifying the network chat entity, the agent identifier being different from the virtual ID.
